(19) United States
(12) Patent Application Publication
(10) Pub. No.: US 2003/0003354 A1
(43) Pub. Date: Jan. 2, 2003

(54) Battery assembly having through-the-wall connection assemblies

(76) Inventors: Elio Ferreira, Danbury, CT (US); Khiem Dinh Pham, Danbury, CT (US); Christine A. Frysz, New Milford, CT (US); Haytham Hussein, Danbury, CT (US)

Correspondence Address: ROBIN BLECKER & DALEY, 2ND FLOOR, 330 MADISON AVENUE, NEW YORK, NY, 10017, US

(21) Appl. No.: 09/896,938

(22) Filed: Jun. 29, 2001

(51) Int. Cl. H01M 2/24

(52) U.S. Cl. 429/160; 429/185

(57) ABSTRACT

A battery assembly having through-the-wall connection assemblies for connecting the electrodes of a first polarity in a given battery compartment to the electrodes of a second polarity in an adjacent battery compartment through an aperture in the internal wall separating the compartments. Each through-the-wall connection assembly includes first and second button or disk shaped members. The first member has opposing first and second surfaces and the second member opposing third and fourth surfaces. The first surface of the first member and the third surface of the second member each have a projection extending outward of the respective surface. The second surface of the first member and the fourth surface of the second member each have a groove and the battery assembly further utilizes first and second elastic members situated in the grooves of the second and third surfaces.

The first and second members of each through-the-wall connection are arranged with the second face of the first member and the fourth face of the second member abutting each other through the aperture in the associated container wall. The projection of the first face of the first member and the projection of the third face of the second member are, in turn, coupled, respectively, to the electrodes of the first polarity in the given compartment and to the electrodes of the second polarity in the adjacent compartment. Welding is used to connect the second and fourth faces of the first and second members together and to connect the first and third faces of the first and second members to the respective electrodes.

### BACKGROUND OF THE INVENTION

This invention relates to battery assemblies and, in particular, to battery assemblies in which the electrodes of the cells are connected in series to form the battery assembly.

Battery assemblies are typically composed of battery cells which are connected electrically in series. Each battery cell is itself composed of a plurality of positive and negative battery electrodes. The positive and negative battery electrodes of a battery cell are connected to respective cell terminals which are assembled through the cell cover. The series intercell connections are then realized by connecting each positive cell terminal with the succeeding negative cell terminal using a metal bus bar.

Attempts have been made to simplify the interconnection between cells by eliminating the bus bars and connecting the cell electrodes through the cell walls. Battery assemblies employing such through-the-wall connections are disclosed, for example, in U.S. Pat. No. 3,914,134.

It is an object of the present invention to provide a battery assembly having improved through-the-wall connection assemblies.

It is also an object of the present invention to provide a battery assembly having through-the-wall connection assemblies which provide improved sealing of the compartments of the battery assembly, enhanced electrical performance, improved manufacturability, better quality and lower cost.

### SUMMARY OF THE INVENTION

In accordance with the principles of the present invention, the above and other objectives are realized in a battery assembly comprised of a container having internal walls which separate the container into compartments. A plurality of sets of electrodes are disposed in each compartment and each set of electrodes includes a number of positive and a number of negative electrodes arranged in interleaved fashion. The battery assembly further comprises a number of through-the-wall connection assemblies. Each through-the-wall connection assembly connects the electrodes of a first polarity in a given compartment to the electrodes of a second polarity in an adjacent compartment through an aperture in the internal wall separating the compartments.

In accord with the invention, each through-the-wall connection assembly includes first and second members. The first member has opposing first and second surfaces and the second member opposing third and fourth surfaces. The first surface of the first member and the third surface of the second member each have a projection extending outward of the respective surface. The second surface of the first member and the fourth surface of the second member each have a groove outward of a predetermined portion of the respective surface and the battery assembly further comprises first and second elastic members situated in the grooves of the second and third surfaces.

The first and second members of each through-the-wall connection assembly are arranged with the predetermined portion of the second face of the first member and the predetermined portion of the fourth face of the second member abutting each other through the aperture in the associated container wall and with the grooved areas of the faces abutting the first and second surfaces of the container wall adjacent such aperture to provide a compression seal around the aperture. The projection of the first face of the first member and the projection of the third face of the second member are, in turn, coupled, respectively, to the electrodes of the first polarity in the given compartment and to the electrodes of the second polarity in the adjacent compartment.

Welding is used to connect the abutting second and fourth faces of the first and second members and to connect the first and third faces of the first and second members to the respective electrodes. The resultant through-the-wall connection assemblies are thus of simpler construction, have improved leakage resistance characteristics, enhanced electrical performance, easier manufacturability, better quality and lower cost.

In the invention to be disclosed hereinafter, the first and second members are of button or disk like configuration, the projections are of dome or hemisphere shape and the battery electrodes are provided with tabs which connect to the respective projections. Also, the grooves follow a circular path and the elastic members are formed as O-rings which snap into the grooves preventing loss during assembly. Additionally, the predetermined portions of the second and fourth surfaces are stepped areas inward of the grooves to facilitate connection of the members. This prevents misalignment and failed welds.

In a further aspect of the invention, the stepped area of the second surface of each first member is provided with a raised annular area and the stepped area of the fourth surface of each second member is provided with a corresponding annular slot which mate when the second and fourth surfaces are brought together. The raised area provides a mechanism for energy concentration during welding, and the annular slot, by engaging the raised area, enhances alignment of the first and second members.

In another version, the stepped area of the second surface of each first member is again provided with a raised annular area for energy concentration during welding and, additionally, inward of the raised area, with a keyway which extends through the stepped area into the body of the first member. In this case, the stepped area of the fourth surface of each second member is provided with a pin which is adapted to mate with the keyway of the associated first member for aligning the members when they are brought together.

### BRIEF DESCRIPTION OF THE DRAWINGS

The above and other features and aspects of the present invention will become more apparent upon reading the following detailed description in conjunction with the accompanying drawings, in which:

FIG. 1 shows an isometric view and FIGS. 2-3 show a top view and simplified side view of a battery assembly in accordance with the principles of the present invention;

FIGS. 4-6 and 7-9 show top, side and bottom views of first and second members of a through-the-wall connection assembly of the battery assembly of FIG.1;

FIG. 10 shows and enlarged schematic view of the connection of the first and second members of a through-the-wall connection assembly at an inner wall of the battery assembly of FIG. 1; and

FIGS. 11 and 12 show modified versions of the first and second members, respectively, of the through-the-wall connection assembly of the invention

### DETAILED DESCRIPTION OF THE INVENTION

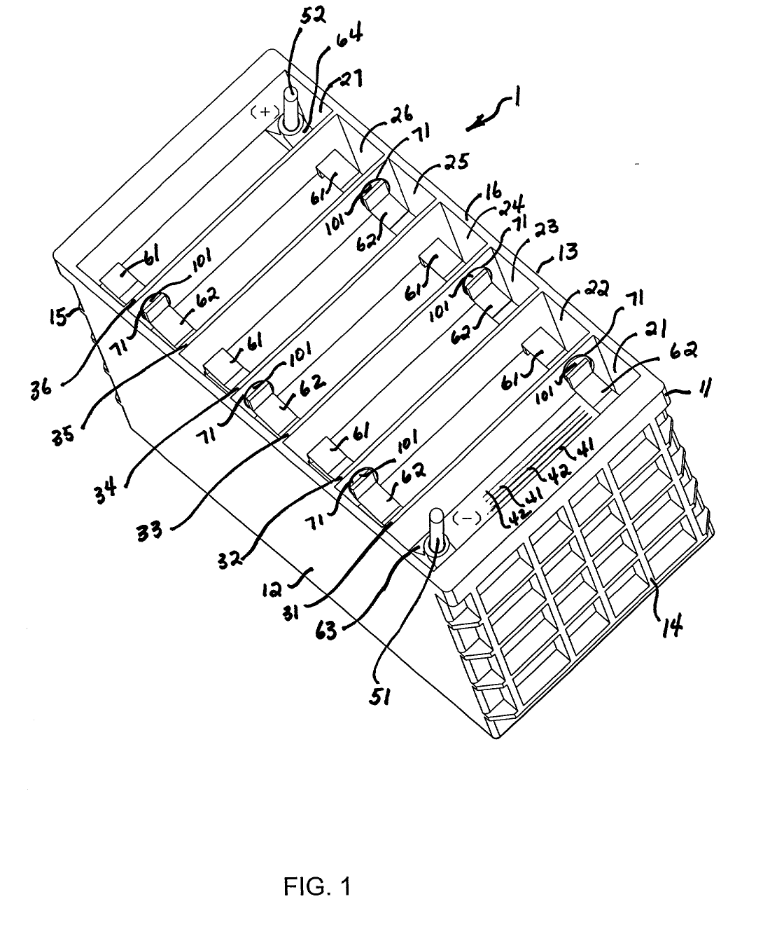

FIG. 1 shows an isometric view and FIGS. 2-3 show a top view and a side view of a battery assembly 1 in accordance with the principles of the present invention. As shown, the battery assembly 1 comprises an outer casing 11 with flat front and back walls 12 and 13 and opposing right and left side walls 14 and 15. A flange area 16 extends about the upper edges of these walls and provides a seating area for a cover 17 (not shown) which closes the top of the battery assembly 1.

The casing 11 is separated into compartments 21-27 by internal walls 31-36. Each compartment houses a set of negative electrodes 41 and a set of positive electrodes 42 which are arranged in spaced interleaved fashion. The first end compartment 21 also houses a negative terminal 51 which extends outward of the compartment and the top cover and serves as the negative battery terminal of the battery assembly 1. Similarly, the second end compartment 27 houses a positive terminal 52 which extends outward of this compartment through the top cover to serve as the positive terminal of the battery assembly.

In order for the negative and positive electrodes 41 and 42 in the battery compartments 21-27 to be electrically connected in series between the negative and positive battery terminals 51 and 52, tabs 61 are connected to the negative electrodes in a compartment and tabs 62 are connected to the positive electrodes in an adjacent compartment and an assembly 101 is provided for connecting the tabs of adjacent compartments. Tabs 63 and tabs 64 are also provided for connecting the negative electrodes of the first end compartment 21 and the positive electrodes of the second end compartment 27 to the respective negative and positive battery terminals 51 and 52.

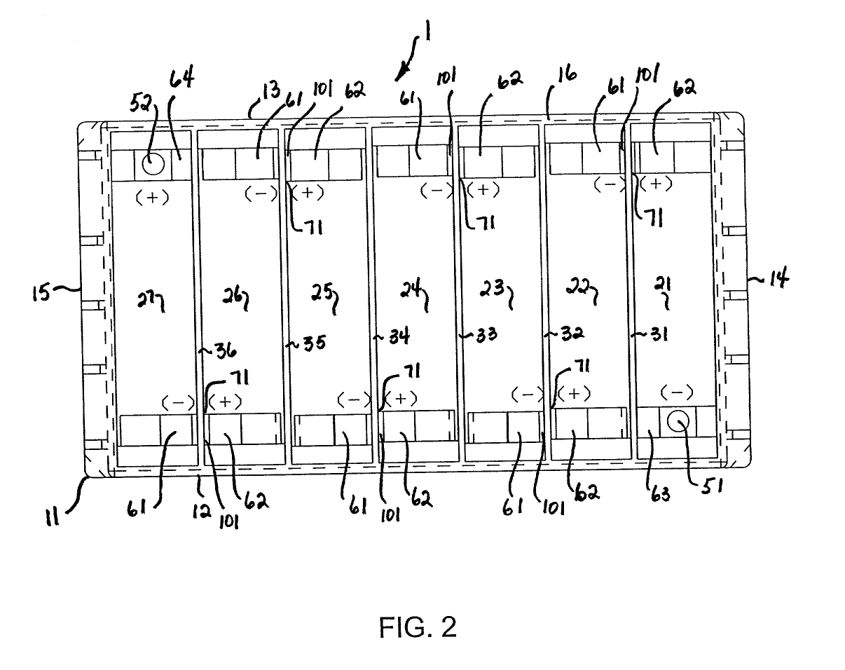

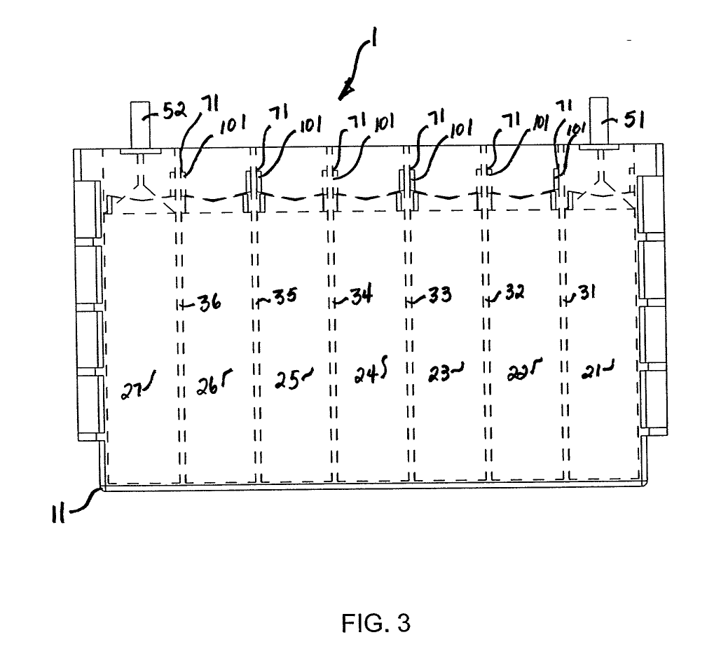

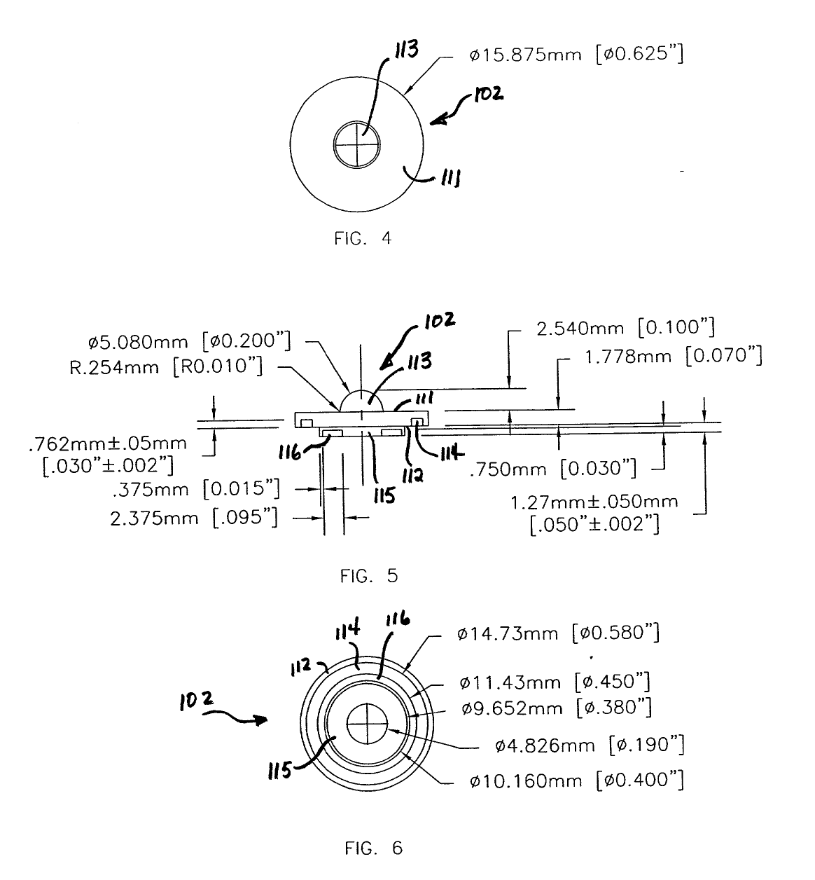

The assemblies 101 for connecting the tabs 61 and the tabs 62 of adjacent compartments are configured as through-the-wall connection assemblies and they connect their respective tabs by extending through apertures 71 in the internal walls 31-36. More particularly, in accordance with the invention, each of the assemblies 101 includes cooperating button or disk members 102 and 103 as shown in FIGS. 4-6 and 7-9, respectively.

As can be seen in FIGS. 4-6, the member 102 is of a circular disk shape with opposing first and second surfaces 111 and 112. Protruding outward from the first surface 111 is a dome or hemisphere shaped projection 113. The second surface 112, in turn, includes a circular groove 114 and inward of the groove a circular stepped region 115. The stepped region 115 also includes an annular slot 116.

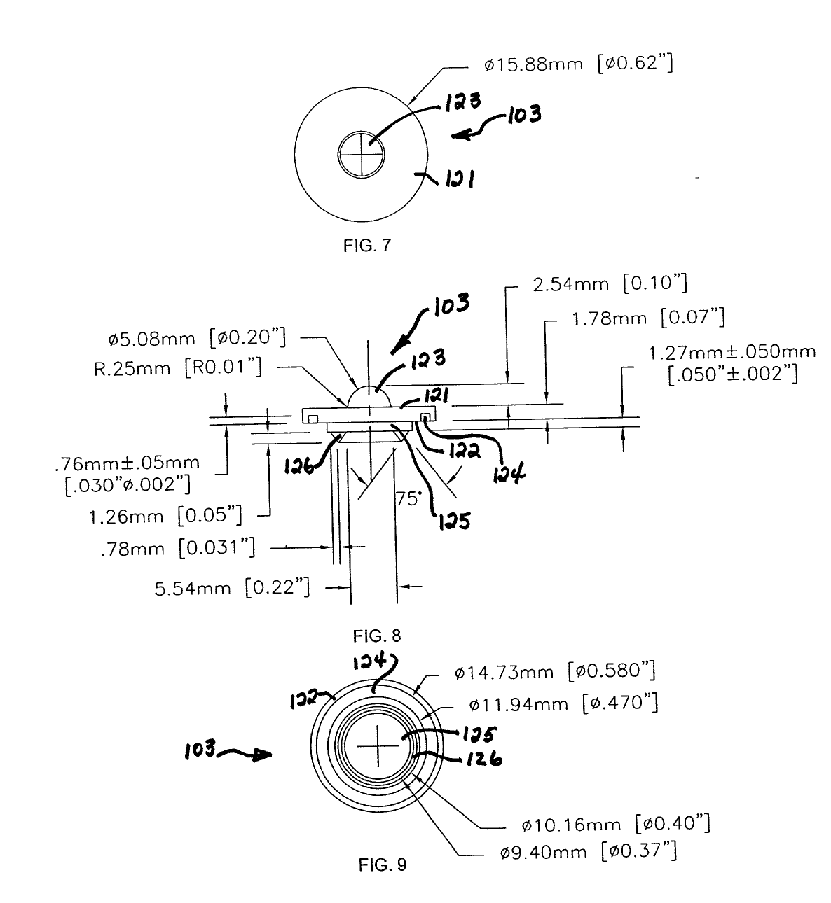

Turning to FIGS. 7-9, the member 103 is also of circular disk shape with opposing first and second surfaces 121 and 122. A dome or hemisphere shaped projection 123 extends outward of the surface 121 and the surface 122 includes a circular groove 124. A stepped region 125 is situated inward of the groove 124 and an annular raised area 126 of triangular cross section extends outward of the stepped area 125.

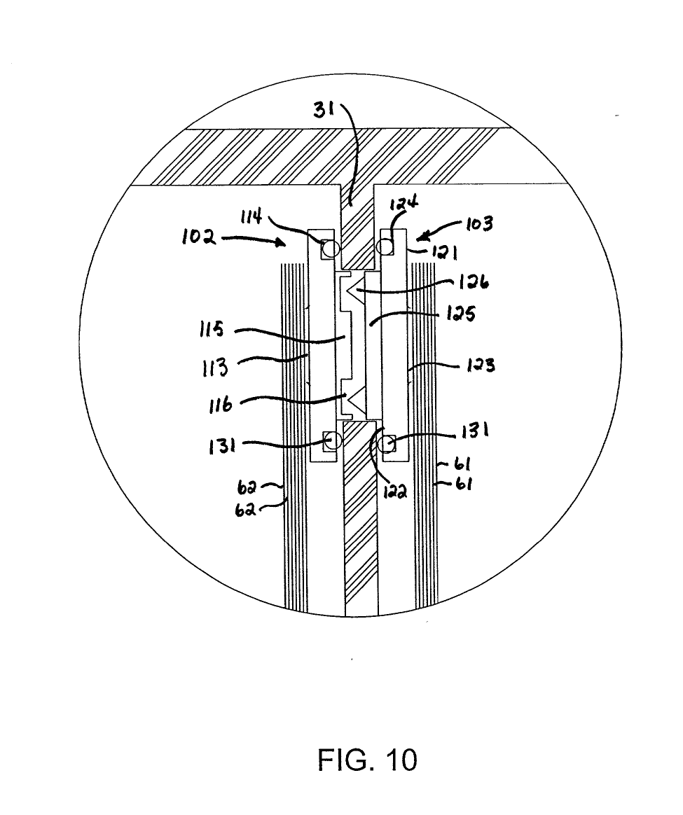

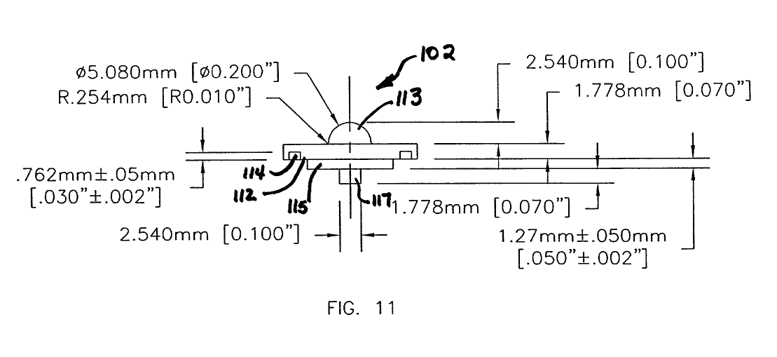

FIG. 10 shows an exploded view of the connection assembly 101 connecting respective tabs 61 and 62 together at the aperture 71 situated in the inner wall 31 between the compartments 21 and 22 of the casing 11. As shown, the grooves 114 and 124 of the members 102 and 103 serve to receive elastic members 131, shown as O-rings, when the assembly 101 is situated in place adjacent the aperture 71. The O-rings are held in the grooves without the need of any additional securing means such as adhesives or solvents.

Additionally, the members 102 and 103 are arranged with the stepped regions 115 and 125 of the surfaces 122 and 132 of the member 103 are placed in aligned abutting relationship. Alignment of the stepped regions is facilitated by the raised area 126 of the stepped area 125 seating in the slot 116 of the stepped area 115. Also, this brings the grooves 114 and 124 of the surfaces 122 and 132 in abutting relationship with the opposing wall surfaces of the wall 31 adjacent the aperture 71.

The presence of the raised area 126 provides an area for concentrating energy when the members 102 and 103 are welded together. Likewise, during welding, the projections 113 and 123 of the members 102 and 103 serve as welding nipples facilitating the welding of the tabs 61 and 62 to the members. The O-rings in the grooves 114 and 124 abutting the wall surfaces further provide a compression seal around the aperture 71.

It should be noted that the stepped area 115 of the second surface 112 of the first member 102 can be formed as a flat surface without the groove 116, if alignment considerations are not of significant concern. In such case, the member 103 can still be provided with the raised area 126 for energy concentration during welding.

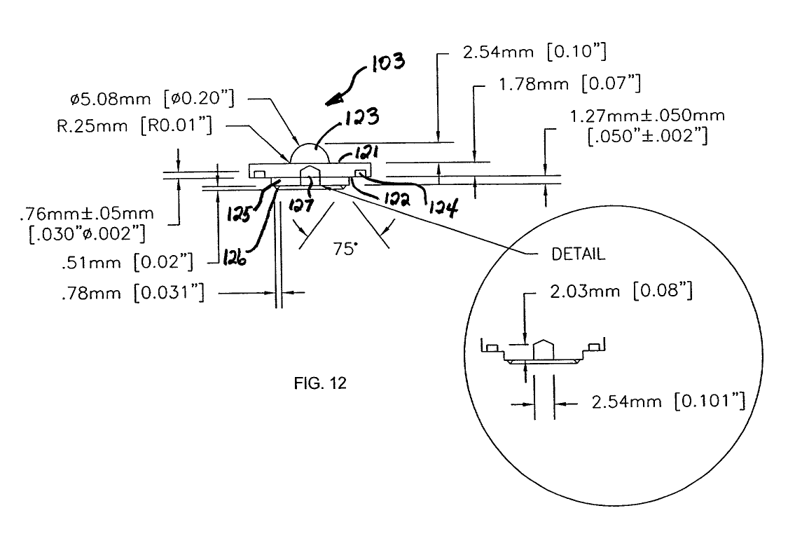

FIGS. 11-12 show sectional views of modified versions of the members 102 and 103, respectively, of the through-the-wall connection assembly 101 of the invention. In these modified versions, the members are provided with additional mating parts which together form an alignment mechanism. In particular, the stepped area 115 of the member 102, instead of having an annular groove, is provided with a central keyway 117. This keyway extends through the stepped area into the body of the member 102. The stepped area 125 of the member 103, in turn, is provided inward of the raised area 126, with a pin 127 configured to mate with the keyway 117.

When the members 102 and 103 of FIGS. 11-12 are brought together, the pin 127 seats in the keyway 117. This ensures alignment of the members and enhances the subsequent welding of the members together.

It should be noted that the casing 11 including the interior walls 31-36 of the casing can be formed from molded plastic. The tabs 62 can be made of nickel and the tabs 61 of silver plated copper. The members 102 and 103 typically can be made from cold rolled steel with a nickel plating and the O-rings 131 from EPDM material. The battery electrodes can be electrodes for any type of battery, including, for example, nickel-zinc batteries.

Typical dimensions for the disk like members 102 and 103 are indicated in FIGS. 4-6 and 7-9.

In all cases it is understood that the above-described arrangements are merely illustrative of the many possible specific embodiments which represent applications of the present invention. Numerous and varied other arrangements can be readily devised in accordance with the principles of the present invention without departing from the spirit and scope of the invention.

What is claimed is:

1. A battery assembly comprising;
a container having internal walls for separating the interior of the container into compartments, each internal wall having opposing first and second wall surfaces;
a plurality of sets of electrodes, each set of electrodes being disposed in a compartment and including a number of positive and a number of negative electrodes, the positive and negative electrodes in each compartment being arranged in interleaved fashion;
a number of through-the-wall connection assemblies, each through-the-wall connection assembly connecting the electrodes of a first polarity in a given compartment to the electrodes of a second polarity in an adjacent compartment through an aperture in the internal wall separating the given compartment and the adjacent compartment and each comprising: a first member having opposing first and second surfaces, said first surface having a projection extending outward of the first surface and said second surface having a groove situated outward of a predetermined portion of the second surface; and a second member having third and fourth opposing surfaces, said third surface having a projection extending outward of the third surface and said fourth surface having a groove situated outward of a predetermined portion of the fourth surface; first and second elastic members situated in the grooves of said second and fourth surfaces;
the first and second members of each through-the-wall connection assembly being arranged with the predetermined portion of the second surface of the first member and the predetermined portion of the fourth surface of the second member abutting each other through the aperture in the associated internal wall and with the groove in the second surface of the first member and the groove in the fourth surface of the second member abutting the first and second wall surfaces, respectively, adjacent the aperture of the associated internal wall, and with the projection of the first surface of the first member and the projection of the third surface of the second member being coupled, respectively, to the electrodes of the first polarity in the given compartment and to the electrodes of the second polarity in the adjacent compartment.

2. A battery assembly in accordance with claim 1, wherein:
said positive and negative electrodes each comprise a tab;
and each electrode connected to a through-the-wall connection assembly has the tab of the electrode coupled to a projection of one of a first and second member of the through-the-wall projection.

3. A battery assembly in accordance with claim 2, wherein:
each first and second member of a through-the-wall connection assembly is of button or disk shape.

4. A battery assembly in accordance with claim 3, wherein
each projection has a dome or hemisphere shape.

5. A battery assembly in accordance with claim 3, wherein:
each groove has a circular path; and
each elastic member is an O-ring.

6. A battery assembly in accordance with claim 5, wherein:
the groove of the second surface of each first member and the groove of the fourth surface of each second member each extend around the perimeter of the respective surface; and
the predetermined portion of the second surface of each first member and the predetermined portion the fourth surface of each second member are each a step region inward of the groove of the respective surface.

7. A battery assembly in accordance with claim 6, wherein:
each step region of a second surface has an annular raised area.

8. A battery assembly in accordance with 7 wherein:
each annular raised area has a triangular cross section.

9. A battery assembly in accordance with 7 wherein:
each step region of a fourth surface has an annular slot arranged to mate with the annular raised area of the associated second surface.

10. A battery assembly in accordance with claim 9, wherein:
the tabs coupled to a projection are coupled by welding; and
the abutting second and fourth surfaces of the first and second members of a through-the-wall connection assembly are coupled together by welding.

11. A battery assembly in accordance with claim 7 wherein:
each step region of a second surface has a keyway situated inward of the raised area and extending through the step region into the body of the first member; and
each step region of a fourth surface has a pin extending from the surface and adapted to mate with the keyway of the associated second surface.

12. A battery assembly in accordance with claim 91, wherein:
the tabs coupled to a projection are coupled by welding; and
the abutting second and fourth surfaces of the first and second members of a through-the-wall connection assembly are coupled together by welding.

13. A battery assembly in accordance with claim 2, wherein
the groove of the second surface of each first member and the groove of the fourth surface of each second member each extend around the perimeter of the respective surface; and
the predetermined portion of the second surface of each first member and the predetermined portion the fourth surface of each second member are each a step region inward of the groove of the respective surface.

14. A battery assembly in accordance with claim 13, wherein
each step region of a second surface has an annular raised area.

15. A battery assembly in accordance with claim 14, wherein:
each raised area has a triangular cross section.

16. A battery assembly in accordance with claim 14 wherein:
each step region of a fourth surface has an annular slot arranged to mate with the annular raised area of the associated second surface.

17. A battery assembly in accordance with claim 16, wherein:
the tabs coupled to a projection are coupled by welding;
the abutting second and fourth surfaces of the first and second members of a through-the-wall connection assembly are coupled together by welding.

18. A battery assembly in accordance with claim 14 wherein:
each step region of a second surface has a keyway inward of the raised area and extending through the step region into the body of the first member; and
each step region of a fourth surface has a pin extending from the surface and adapted to mate with the keyway of the associated second surface.

19. A battery assembly in accordance with claim 18, wherein:
the tabs coupled to a projection are coupled by welding; and
the abutting second and fourth surfaces of the first and second members of a through-the-wall connection assembly are coupled together by welding.

20. A battery assembly in accordance with claim 2, wherein:
the tabs coupled to a projection are coupled by welding; and
the abutting second and fourth surfaces of the first and second members of a through-the-wall connection assembly are coupled together by welding.

21. A battery assembly in accordance with claim 1, further comprising;
a positive battery terminal situated in a first of said compartments and connected to the positive electrodes in said first of said compartments; and
a negative battery terminal situated in a second of said compartments and connected to the negative electrodes in said second of said compartments.

22. A battery assembly in accordance with claim 21, wherein:
said first and second compartments are the compartments at the opposite ends of said housing.

23. A through-the-wall connection assembly for connecting the electrodes of a first polarity in a given compartment of a housing of a battery assembly to the electrodes of a second polarity in an adjacent compartment of the housing of the battery assembly, the connection being through an aperture in an internal wall in the housing separating the given compartment and the adjacent compartment, the internal wall having first and second opposing wall surfaces and the through-the-wall connection assembly comprising: a first member having opposing first and second surfaces, said first surface having a projection extending outward of the first surface and said second surface having a groove situated outward of a predetermined portion of the second surface; and a second member having third and fourth opposing surfaces, said third surface having a projection extending outward of the third surface and said fourth surface having a groove situated outward of a predetermined portion of the fourth surface; and first and second elastic members situated in the grooves of said second and fourth surfaces;
the first and second members being adapted to be arranged with the predetermined portion of the second surface of the first member and the predetermined portion of the fourth surface of the second member abutting each other through the aperture in the internal wall and with the groove in the second surface of the first member and the groove in the fourth surface of the second member abutting the first and second wall surfaces, respectively, adjacent the aperture of the internal wall, and with the projection of the first surface of the first member and the projection of the third surface of the second member being coupled, respectively, to the electrodes of the first polarity in the given compartment and to the electrodes of the second polarity in the adjacent compartment.

24. A through-the-wall connection assembly in accordance with claim 23, wherein:
each of said electrodes of first polarity and each of said electrodes of second polarity comprise a tab;
and said first and second members are further adapted to be arranged with the projection of the first surface of the first member and the projection of the third surface of the second member being coupled, respectively, to the tabs of the electrodes of the first polarity in the given compartment and to the tabs of the electrodes of the second polarity in the adjacent compartment.

25. A through-the-wall connection assembly in accordance with claim 24, wherein:
said first and second members are each of a button or disk shape.

26. A through-the-wall connection assembly in accordance with claim 25, wherein
each projection has a dome or hemisphere shape.

27. A through-the-wall connection assembly in accordance with claim 25, wherein:
each groove has a circular path; and
each elastic member is an O-ring.

28. A through-the-wall connection assembly in accordance with claim 27, wherein:
the groove of the second surface of said first member and the groove of the fourth surface of said second member each extend around perimeter of the respective surface; and
the predetermined portion of the second surface of said first member and the predetermined portion of the fourth surface of second member are each a step region inward of the groove of the respective surface.

29. A through-the-wall connection assembly in accordance with claim 28, wherein:
the step region of said second surface has an annular raised area.

30. A through-the-wall connection assembly in accordance with 29, wherein:
the raised area has a triangular cross section.

31. A through-the-wall connection assembly in accordance with claim 29, wherein:
the step region of said fourth surface has an annular slot arranged to mate with the annular raised area of the associated second surface.

32. A through-the-wall connection assembly in accordance with claim 31, wherein:
the first and second members are further adapted to be arranged with the second surface of the first member and the fourth surface of the second member welded to each other through the aperture in the associated internal wall and with the projection of the first surface of the first member and the projection of the third surface of the second member being welded, respectively, to the tabs of the electrodes of the first polarity in the given compartment and to the tabs of the electrodes of the second polarity in the adjacent compartment.

33. A through-the-wall connection assembly in accordance with claim 29, wherein:
the step region of the second surface has a keyway inward of the raised area and extending through the step region into the body of the first member; and
the step region of a fourth surface has a pin extending from the surface and adapted to mate with the keyway of the associated second surface.

34. A through-the-wall connection assembly in accordance with claim 33, wherein:
the first and second members are further adapted to be arranged with the second surface of the first member and the fourth surface of the second member welded to each other through the aperture in the associated internal wall and with the projection of the first surface of the first member and the projection of the third surface of the second member being welded, respectively, to the tabs of the electrodes of the first polarity in the given compartment and to the tabs of the electrodes of the second polarity in the adjacent compartment.

35. A through-the-wall connection assembly in accordance with claim 24, wherein:
the groove of the second surface of said first member and the groove of the fourth surface of said second member each extend around perimeter of the respective surface; and
the predetermined portion of the second surface of said first member and the predetermined portion of the fourth surface of second member are each a step region inward of the groove of the respective surface.

36. A through-the-wall connection assembly in accordance with claim 35, wherein:
the step region of said second surface has an annular raised area.

37. A through-the-wall connection assembly in accordance with claim 36, wherein:
the raised area has a triangular cross section.

38. A through-the-wall connection assembly in accordance with claim 37, wherein:
said first and second members are each of a button or disk shape.

39. A through-the-wall connection assembly in accordance with claim 36, wherein:
said first and second members are each of a button or disk shape.

40. A through-the-wall connection assembly in accordance with claim 35 wherein:
the step region of said fourth surface has an annular slot arranged to mate with the annular raised area of the associated second surface.

41. A through-the-wall connection assembly in accordance with claim 40, wherein:
the first and second members are further adapted to be arranged with the second surface of the first member and the fourth surface of the second member welded to each other through the aperture in the associated internal wall and with the projection of the first surface of the first member and the projection of the third surface of the second member being welded, respectively, to the tabs of the electrodes of the first polarity in the given compartment and to the tabs of the electrodes of the second polarity in the adjacent compartment.

42. A through-the-wall connection assembly in accordance with claim 36, wherein:
the step region of the second surface has a keyway inward of the raised area and extending through the step region into the body of the first member; and
the step region of a fourth surface has a pin extending from the surface and adapted to mate with the keyway of the associated second surface.

43. A through-the-wall connection assembly in accordance with claim 42, wherein:
the first and second members are further adapted to be arranged with the second surface of the first member and the fourth surface of the second member welded to each other through the aperture in the associated internal wall and with the projection of the first surface of the first member and the projection of the third surface of the second member being welded, respectively, to the tabs of the electrodes of the first polarity in the given compartment and to the tabs of the electrodes of the second polarity in the adjacent compartment.

44. A through-the-wall connection assembly in accordance with claim 24, wherein:
the predetermined portion of the second surface of said first member and the predetermined portion of the fourth surface of second member are each a step region inward of the groove of the respective surface;
the step region of the second surface has a keyway inward of the raised area and extending through the step region into the body of the first member; and
the step region of a fourth surface has a pin extending from the surface and adapted to mate with the keyway of the associated second surface.

45. A battery assembly comprising;
a container having internal walls separating the interior of the container into compartments, each internal wall having first and second opposing wall surfaces:
a plurality of sets of electrode's, each set of electrodes being disposed in a compartment and including a number of positive and a number of negative electrodes, the positive and negative electrodes in each compartment being arranged in interleaved fashion;
a number of through-the-wall connection assemblies, each through-the-wall connection assembly connecting the electrodes of a first polarity in a given compartment to the electrodes of a second polarity in an adjacent compartment through an aperture in the internal wall separating the given compartment and the adjacent compartment and each comprising: a first member having opposing first and second surfaces; and a second member having third and fourth opposing surfaces;
the first and second members of each through-the-wall connection assembly being arranged with at least a predetermined portion of the second surface of the first member and at least a predetermined portion of the fourth surface of the second member abutting each other through the aperture in the associated internal wall and with the first surface of the first member and the third surface of the second member being coupled, respectively, to the electrodes of the first polarity in the given compartment and to the electrodes of the second polarity in the adjacent compartment.

46. A battery assembly in accordance with claim 45, wherein:
said positive and negative electrodes each comprise a tab;
and each electrode connected to a through-the-wall connection assembly has the tab of the electrode coupled to one of the first surface of the first member and third surface of the second member of the through-the-wall connection assembly.

47. A battery assembly in accordance with claim 46, wherein:
each first surface of each first member has a projection and each third surface of each second member has a projection, the projection of the first surface of each first member and the projection of the third surface of each second member being coupled to the tabs of the electrodes coupled to that member.

48. A battery assembly in accordance with claim 45, wherein:
each first and second member of a through-the-wall connection assembly is of button or disk shape.

49. A battery assembly in accordance with claim 45, wherein:
each second surface of each first member has a groove situated outward of the predetermined portion of the second surface and each fourth surface of each second member has a groove situated outward of the predetermined portion of the fourth surface;
said battery assembly further includes an elastic member in each of said grooves;
and said first and second members of each through-the-wall assembly are further arranged with the groove in the second surface of the first member and the groove in the fourth surface of the second member abutting first and second wall surfaces, respectively, adjacent the aperture of the associated internal wall.

50. A battery assembly in accordance with claim 49 wherein:
the groove of the second surface of each first member and the groove of the fourth surface of each second member extends around perimeter of the respective surface;
the predetermined portion of each second surface of each first member and the predetermined portion of each fourth surface of each second member are each a step region inward of the groove of the respective surface;
each step region of a second surface has an annular raised area.

51. A battery assembly in accordance with claim 50, wherein:
each step region of a fourth surface has an annular slot arranged to mate with the annular raised area of the associated second surface.

52. A battery assembly in accordance with claim 50, wherein:
each step region of a second surface has a keyway inward of the raised area and extending through the step region into the body of the first member; and
each step region of a fourth surface has a pin extending from the surface and adapted to mate with the keyway of the associated second surface.

53. A battery assembly in accordance with claim 45, wherein:
each second surface of each first member has a groove outward of the predetermined portion of the second surface and each fourth surface of each second member has a groove outward of the predetermined portion of the fourth surface;
said battery assembly further includes an elastic member in each of said grooves;
and said first and second members of each through-the-wall assembly are further arranged with the groove in the second surface of the first member and the groove in the fourth surface of the second member abutting the first and second wall surfaces, respectively, adjacent the aperture of the associated internal wall.

54. A battery assembly in accordance with claim 45, wherein:
the predetermined portion of the second surface of each first member has a raised area.

55. A battery assembly in accordance with claim 54, wherein:
the predetermined portion of the fourth surface of each second member has a slot arranged to mate with the raised area of the associated second surface.

56. A battery assembly in accordance with claim 55, wherein:
the predetermined portion of each second surface of each first member and the predetermined portion of each fourth surface of each second member are each a step region.

57. A battery assembly in accordance with claim 56, wherein:
the raised area of each second surface and the slot of each fourth surface are each annular.

58. A battery assembly in accordance with claim 54, wherein:
each second surface of each first member has a groove outward of the predetermined portion of the second surface and each fourth surface of each second member has a groove outward of the predetermined portion of the fourth surface;
said battery assembly further includes an elastic member in each of said grooves;
and said first and second members of each through-the-wall assembly are further arranged with the groove in the second surface of the first member and the groove in the fourth surface of the second member abutting the first and second wall surfaces, respectively, adjacent the aperture of the associated internal wall.

59. A battery assembly in accordance with claim 45, wherein the predetermined portion of the second surface of each first member has a keyway extending into the body of the first member; and
the predetermined portion of the fourth surface of each second member has a pin extending from the surface and adapted to mate with the keyway of the associated second surface.

60. A battery assembly in accordance with claim 59, wherein:
the predetermined portion of each second surface of each first member and the predetermined portion of each fourth surface of each second member are each a step region.

61. A through-the-wall connection assembly for connecting the electrodes of a first polarity in a given compartment of a housing of a battery assembly to the electrodes of a second polarity in an adjacent compartment of the housing of the battery assembly, the connection being through an aperture in an internal wall in the housing separating the given compartment and the adjacent compartment, said through-the-wall connection assembly comprising: a first member having opposing first and second surfaces; and a second member having third and fourth opposing surfaces;
the first and second members being adapted to be arranged with at least a predetermined portion of the second surface of the first member and at least a predetermined portion of the fourth surface of the second member abutting each other through the aperture in the associated internal wall and with the first surface of the first member and the third surface of the second member being coupled, respectively, to the electrodes of the first polarity in the given compartment and to the electrodes of the second polarity in the adjacent compartment.

62. A through-the-wall connection assembly in accordance with claim 61, wherein:
each of said electrodes of first polarity and each of said electrodes of second polarity comprise a tab;
and said first and second members are further adapted to be arranged with the first surface of the first member and the third surface of the second member being coupled, respectively, to the tabs of the electrodes of the first polarity in the given compartment and to the tabs of the electrodes of the second polarity in the adjacent compartment.

63. A through-the-wall connection assembly in accordance with claim 62, wherein:
the first surface of the first member has a projection and the third surface of the second member has a projection, the first and second members being further adapted to be arranged with the projection of the first surface of the first member and the projection of the third surface of the second member being coupled to the tabs of the electrodes coupled to that member.

64. A through-the-wall connection assembly in accordance with claim 61, wherein:
each first and second member of said through-the-wall connection assembly is of button or disk shape.

65. A through-the-wall connection assembly in accordance with claim 61, wherein:
the second surface of the first member has a groove situated outward of the predetermined portion of the second surface and the fourth surface of the second member has a groove situated outward of the predetermined portion of the fourth surface;
said through-the-wall connection assembly further includes an elastic member in each of said grooves;
and said first and second members are further adapted to be arranged with the groove in the second surface of the first member and the groove in the fourth surface of the second member abutting first and second wall surfaces, respectively, adjacent the aperture of the associated internal wall.

66. A through-the-wall connection assembly in accordance with claim 65, wherein:
the groove of the second surface of the first member and the groove of the fourth surface of the second member each extend around perimeter of the respective surface;
the predetermined portion of the second surface of the first member and the predetermined portion of the fourth surface of the second member are each a step region inward of the groove of the respective surface;
the step region of a second surface has an annular raised area.

67. A through-the-wall connection assembly in accordance with claim 66, wherein:
the step region of the fourth surface has an annular slot arranged to mate with the annular raised area of the associated second surface.

68. A through-the-wall connection assembly in accordance with claim 66, wherein:
the step region of the second surface has a keyway inward of the raised area and extending through the step region into the body of the first member; and
the step region of the fourth surface has a pin extending from the surface and adapted to mate with the keyway of the associated second surface.

69. A through-the-wall connection assembly in accordance with claim 61, wherein:
the second surface of the first member has a groove outward of the predetermined portion of the second surface and the fourth surface of the second member has a groove outward of the predetermined portion of the fourth surface;
said through-the-wall connection assembly further includes an elastic member in each of said grooves;
and said first and second members of each through-the-wall assembly are further adapted to be arranged with the groove in the second surface of the first member and the groove in the fourth surface of the second member abutting the first and second wall surfaces, respectively, adjacent the aperture of the internal wall.

70. A through-the-wall connection assembly in accordance with claim 61, wherein:
the predetermined portion of the second surface of the first member has a raised area.

71. A through-the-wall connection assembly in accordance with claim 70, wherein:
the predetermined portion of the fourth surface of the second member has a slot arranged to mate with the raised area of the associated second surface.

72. A through-the-wall connection assembly in accordance with claim 71, wherein:
the predetermined portion of the second surface of the first member and the predetermined portion of the fourth surface of each second member are each a step region.

73. A through-the-wall connection assembly in accordance with claim 72, wherein:
the raised area of the second surface and the slot of the fourth surface are each annular.

74. A through-the-wall connection assembly in accordance with claim 70, wherein:
the second surface of the first member has a groove outward of the predetermined portion of the second surface and the fourth surface of the each second member has a groove outward of the predetermined portion of the fourth surface;
said through-the-wall connection assembly further includes an elastic member in each of said grooves;
and said first and second members of each through-the-wall assembly are further adapted to be arranged with the groove in the second surface of the first member and the groove in the fourth surface of the second member abutting the first and second wall surfaces, respectively, adjacent the aperture in the internal wall.

75. A through-the-wall connection assembly in accordance with claim 61, wherein
the predetermined portion of the second surface of the first member has a keyway extending into the body of the first member; and
the predetermined portion of the fourth surface of the second member has a pin extending from the surface and adapted to mate with the keyway of the associated second surface.

76. A through-the-wall connection assembly in accordance with claim 75, wherein:
the predetermined portion of each second surface of each first member and the predetermined portion of each fourth surface of each second member are each a step region.
